(19) United States
(12) Patent Application Publication
(10) Pub. No.: US 2013/0315242 A1
(43) Pub. Date: Nov. 28, 2013

(54) Network Communication Method and Device

(71) Applicant: HUAWEI TECHNOLOGIES CO., LTD., SHENZHEN (CN)

(72) Inventors: Yuchen Wang, Beijing (CN); Lifeng Liu, Beijing (CN); Yujia Weng, Chengdu (CN)

(73) Assignee: HUAWEI TECHNOLOGIES CO., LTD., SHENZHEN (CN)

(21) Appl. No.: 13/745,405

(22) Filed: Jan. 18, 2013

Related U.S. Application Data
(63) Continuation of application No. PCT/CN2012/075878, filed on May 22, 2012.

(51) Int. Cl. H04L 12/56

(52) U.S. Cl. CPC H04L 45/74
USPC 370/392

(57) ABSTRACT

The present invention provides a network communication method and device. The method includes: receiving, by a VNC on a physical host, a network communication packet sent by a first virtual machine of which a host machine is the physical host and which has a mapping relationship with the VNC, where a source address carried in the network communication packet is an address of the first virtual machine, a destination address carried in the network communication packet is an address of a second virtual machine or an address of another physical host; selecting, by the physical host, a VPN network corresponding to the VNC on the physical host according to preset correspondence between the VPN network and the VNC; and sending, by the physical host, the network communication packet through the selected VPN network. The present invention lowers the restriction on setting an IP address of a virtual machine in a VPN.

### CROSS-REFERENCE TO RELATED APPLICATIONS

This application is a continuation of International Application No. PCT/CN2012/075878, filed on May 22, 2012, which is hereby incorporated by reference in its entirety.

### FIELD

The present invention relates to the field of communications technologies, and in particular, to a network communication method and device.

### BACKGROUND

In a data center, service systems of different users have their own infrastructures such as computers and networks, and infrastructures of different service systems are independent of each other; therefore, information isolation between the service systems can be guaranteed by means of network physical isolation, so as to prevent information leakage of the service systems. For example, a computer and a network of a finance system are isolated from other service systems, so as to guarantee that users of other service systems cannot thieve data in the finance system through the network.

Virtualization refers to that computer components run on a virtual basis instead of a real basis. In the virtualization technology of a CPU, a single CPU can simulate multiple CPUs in parallel, running of multiple operating systems on one platform is allowed, and applications can be run in mutually independent spaces without affecting each other, so as to remarkably improve the working efficiency of the computer. Because of the advantage of the virtualization technology in improving the working efficiency, applying the virtualization technology in a data center has become a hot spot in current technical research. However, after the data center is virtualized, a user service is run by a virtual machine installed on a physical computer instead of the physical computer, different virtual machines that belong to different tenants may run on the same physical host, and different service systems formed by the virtual machines share the same network infrastructure. At this time, isolation of information systems is difficult to be implemented. For example, a finance system and a research and development system use different virtual machines, but different virtual machines run on the same physical host or are located in the same network, so that a user may thieve data in the finance system by means of address spoofing, network monitoring, and so on, through a computer in the research and development system. Therefore, in case that different tenants share the same physical infrastructure, how to classify virtual machines into different virtual networks across the physical boundary and guarantee information isolation between the virtual networks becomes a basic requirement for guaranteeing security of multiple tenants in the virtualized data center.

In the prior art, to solve the network security problem when different tenants share the same physical infrastructure, generally, conventional virtual private network (VPN) software needs to be installed in a guest system of each virtual machine, so as to isolate virtual machines belonging to different service systems in different VPN networks, thereby implementing security communication between virtual machines in the same service network, and network traffic is encrypted, so as to prevent network communication content from being thieved by other users on the shared infrastructure.

Moreover, in the prior art, when an IP address of a virtual machine is configured, the IP address of the virtual machine cannot be set to be the same as an IP address of a physical host, and a virtual IP address in a VPN and a real IP address of the virtual machine need to be set in different network segments; otherwise, an IP address conflict in a network and disorder of a routing table in the physical host are caused.

Therefore, settings that need to be performed for implementing security communication relevant to a virtual machine are complicated in the prior art.

### SUMMARY

Embodiments of the present invention provide a network communication method and device, so as to solve the problem that settings that need to be performed for implementing security communication relevant to a virtual machine are complicated in the prior art.

In a first aspect, an embodiment of the present invention provides a network communication method, which includes: receiving, by a virtual private network VPN network card (VNC) on a physical host, a network communication packet sent by a first virtual machine of which a host machine is the physical host and which has a mapping relationship with the VNC, where a source address carried in the network communication packet is an address of the first virtual machine, and a destination address carried in the network communication packet is an address of a second virtual machine or address of another physical host; selecting, by the physical host, a VPN network corresponding to the VNC on the physical host according to preset correspondence between the VPN network and the VNC; and sending, by the physical host, the network communication packet through the selected VPN network.

In another aspect, an embodiment of the present invention provides a network communication device, which includes: a packet capturing module, configured to receive, through a VNC on a physical host where the network communication device is located, a network communication packet sent by a first virtual machine of which a host machine is the physical host and which has a mapping relationship with the VNC, where a source address carried in the network communication packet is an address of the first virtual machine, and a destination address carried in the network communication packet is an address of a second virtual machine or address of another physical host; a selection module, configured to select a VPN network corresponding to the VNC on the physical host according to preset correspondence between the VPN network and the VNC; and a first sending module, configured to send the network communication packet through the selected VPN network.

The technical effects of the embodiments of the present invention are as follows. A VNC on a physical host receives a network communication packet sent by a first virtual machine of which a host machine is the physical host and which has a mapping relationship with the VNC, a VPN network corresponding to the VPN network card is selected according to preset correspondence between the VPN network and the VNC, and the network communication packet is sent through the selected VPN network. Through this solution, it is unnecessary to install VPN software on each virtual machine, which simplifies the setting procedure, an IP address of a virtual machine is allowed to be the same as an IP address of a physical computer, and the same IP address is allowed to be set for different virtual machines that are installed on the same virtual machine management system and belong to different VPN networks, so as to lower the restriction on setting an IP address of a virtual machine in a VPN.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flow chart of Embodiment 1 of a network communication method according to the present invention;

FIG. 2 is a flow chart of Embodiment 2 of the network communication method according to the present invention;

FIG. 3 is a schematic view 1 of communication between virtual machines in Embodiment 2 of the network communication method according to the present invention;

FIG. 4 is a schematic view 2 of communication between virtual machines in Embodiment 2 of the network communication method according to the present invention;

FIG. 5 is a flow chart of Embodiment 3 of the network communication method according to the present invention;

FIG. 6 is a structural diagram of Embodiment 1 of a network communication device according to the present invention; and

FIG. 7 is a structural diagram of Embodiment 2 of the network communication device according to the present invention.

### DETAILED DESCRIPTION OF THE EMBODIMENTS

To make the objectives, technical solutions, and advantages of the embodiments of the present invention more clearly, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

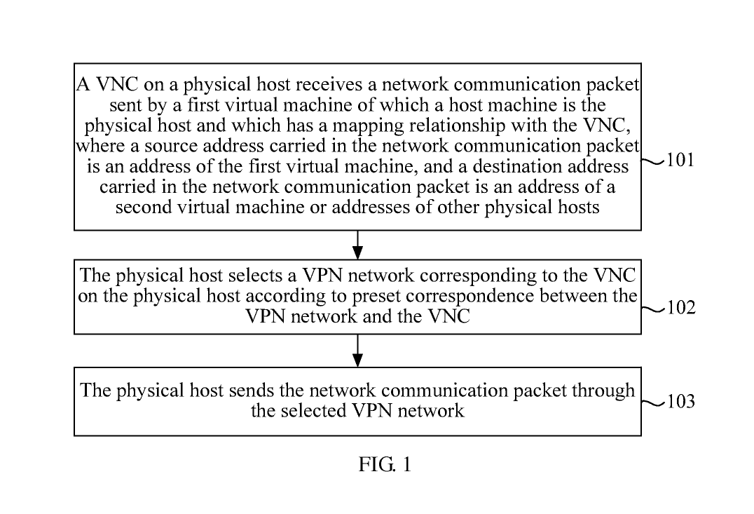

FIG. 1 is a flow chart of Embodiment 1 of a network communication method according to the present invention. As shown in FIG. 1, this embodiment provides a network communication method, which may specifically include the following steps:

Step 101: A VPN network card (VPN Network Card, VNC for short) on a physical host receives a network communication packet sent by a first virtual machine of which a host machine is the physical host and which has a mapping relationship with the VNC, where a source address carried in the network communication packet is an address of the first virtual machine, and a destination address carried in the network communication packet is an address of a second virtual machine or address of another physical host.

This step may specifically be that a VNC on a physical host receives a network communication packet sent by a first virtual machine, where a source address and a destination address are carried in the network communication packet. Herein, the source address may be a MAC address of the first virtual machine that sends the network communication packet or the first virtual machine's virtual IP address in a VPN network to which the first virtual machine belongs, the destination address may be a MAC address of a second virtual machine that receives the network communication packet or the second virtual machine's virtual IP address in a VPN network to which the second virtual machine belongs, and the destination address may also be MAC address of another physical host that receive the network communication packet or the another physical hosts' virtual IP address in a VPN network to which the another physical host belong. It should be noted that, a virtual IP address of a virtual machine refers to an IP address allocated and used in a VPN network where the virtual machine is located, and the virtual IP address is unique in the VPN network where the virtual machine is located. Certainly, virtual IP addresses in different VPN networks may be repeated. The first virtual machine is a virtual machine of which a host machine is the physical host and which has a mapping relationship with the VNC, the second virtual machine may also be other virtual machines of which host machines are the physical host and which have a mapping relationship with the VNC on the physical host, and the second virtual machine may further be a virtual machine of which a host machine is other physical hosts and which belongs to the same VPN network as the first virtual machine.

Step 102: The physical host selects a VPN network corresponding to the VNC on the physical host according to preset correspondence between the VPN network and the VNC.

After capturing the network communication packet sent by the first virtual machine, the physical host selects, according to preset correspondence between the VPN network and the VNC, a VPN network corresponding to the VNC that receives the network communication packet, that is, the physical host obtains a VPN network to which the first virtual machine belongs, so as to learn a VPN network in which the network communication packet should be sent. In this embodiment, multiple virtual machines and multiple VNCs are set on the physical host, each VNC corresponds to at least one virtual machine (that is, receives a network communication packet sent by at least one virtual machine), and each VNC corresponds to one VPN network. Before communication between the virtual machines, correspondence between the VPN network and the VNC may be preset according to a preconfigured VPN security communication policy.

Step 103: The physical host sends the network communication packet through the selected VPN network.

After selecting the VPN network corresponding to the VNC on the physical host, the physical host may send the network communication packet through the selected VPN network, which may specifically be that the network communication packet is sent to the second virtual machine or another physical host corresponding to the destination address. In this embodiment, the first virtual machine may send a network communication packet to the second virtual machine that belongs to the same physical host, and may also send a network communication packet to the second virtual machine that does not belong to the same physical host, and may further send a network communication packet to other physical hosts. Because all network communication packets sent by the first virtual machine are sent through corresponding VPN networks, a physical host can see physical IP addresses of hosts of both communication parties only and cannot see a virtual IP address of an internal layer virtual machine in the same VPN network, and in addition, during communication with each other, a virtual machine only can see a virtual IP address or a MAC address of a virtual machine, and cannot see a physical IP address or a MAC address of a host, so that a function of network isolation between a physical host and a virtual machine is achieved. When different virtual machines are installed on the same physical host, even though an IP address of the physical host coincides with a virtual IP address of a virtual machine, a phenomenon such as an address conflict does not occur, or virtual machines that belong to different VPN networks cannot communicate with each other even though IP addresses of the same network segment are set. It can be seen that, in this embodiment, all outgoing traffic of a virtual machine can be directed through a VPN network directly, a network communication packet does not need to be forwarded through a routing table in a Guest OS, and traffic is no longer differentiated through IP addresses, so as to implement network isolation between virtual machines, thereby lifting the restriction on an IP address during communication between the virtual machines.

Through the network communication method provided by this embodiment, a VNC on a physical host receives a network communication packet sent by a first virtual machine of which a host machine is the physical host and which has a mapping relationship with the VNC, a VPN network corresponding to the VNC is selected according to preset correspondence between the VPN network and the VNC, and the network communication packet is sent through the VPN network. Through this solution, it is unnecessary to install VPN software on each virtual machine, which simplifies the setting procedure, an IP address of a virtual machine is allowed to be the same as an IP address of a physical computer, and the same IP address is allowed to be set for different virtual machines that are installed on the same virtual machine management system and belong to different VPN networks, so as to lower the restriction on setting an IP address of a virtual machine in a VPN.

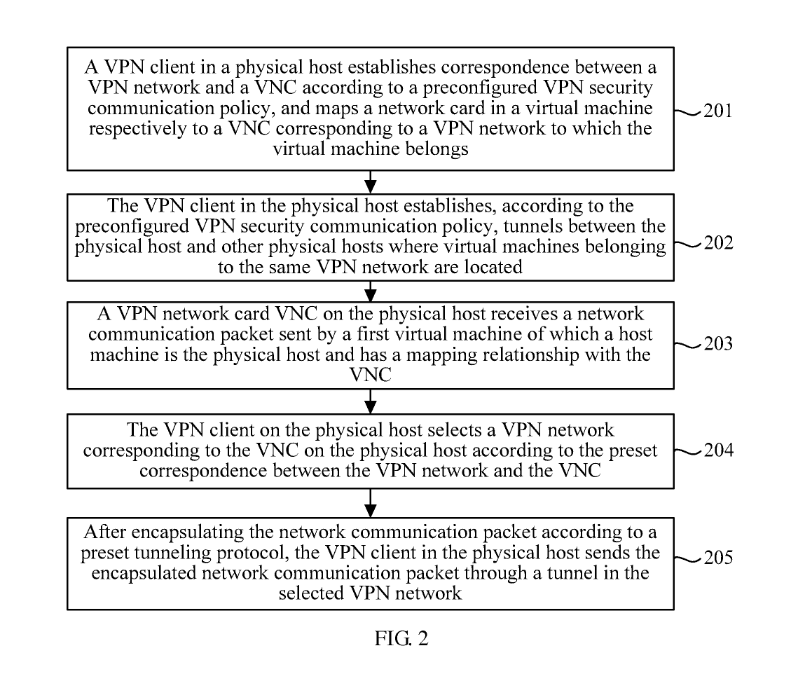

FIG. 2 is a flow chart of Embodiment 2 of a network communication method according to the present invention. In this embodiment, a VPN client in a physical host is taken as an example to describe the network communication method provided by this embodiment. Apparently, steps in FIG. 2 may also be performed by other software or hardware modules in the physical host.

A VPN client is directly installed in a host operating system (Host Operating System, Host OS for short) or a virtual machine manager (Hypervisor) in the host operating system, without the need of installing any software in a Guest OS of a virtual machine. The VPN client may manage multiple VNCs that belong to different VPN networks in one physical host, and the VNCs are also installed in the host operating system or the virtual machine manager. A host in the “host operating system” refers to a physical host. For example, a Linux system is installed on the physical host, a Vmware Desktop virtual machine Hypervisor is further installed on the Linux system, a user establishes one virtual machine on the Vmware Desktop, and windows XP is installed in the virtual machine. At this time, the Linux system on the physical host is a Host OS, the Windows XP installed in the virtual machine is a Guest OS, and the Vmware Desktop software is a Hypervisor.

As shown in FIG. 2, this embodiment provides a network communication method, which may specifically include the following steps:

Step 201: A VPN client in a physical host establishes correspondence between a VPN network and a VNC according to a preconfigured VPN security communication policy, and maps a network card in a virtual machine respectively to a VNC corresponding to a VPN network to which the virtual machine belongs.

In this embodiment, a deployment manner of a VPN client in the prior art is changed, the VPN client is installed on a Host OS or a Hypervisor, at least one VNC is set on the VPN client, and each VNC corresponds to one VPN network, without the need of installing any software in a Guest system of each virtual machine. In this embodiment, the main function of a VPN client is to obtain a VPN security communication policy and manage a VNC. This step is that a VPN client in a physical host establishes correspondence between a VPN network and a VNC according to a preconfigured VPN security communication policy, and maps a network card in each virtual machine to a VNC corresponding to a VPN network to which the virtual machine belongs. Optionally, in the actual implementation process, a VPN client in each physical host may establish correspondence between a VPN network and a VNC on the physical host according to a preconfigured VPN security communication policy, and map a network card in each virtual machine on the physical host respectively to a VNC on the physical host, where the VNC corresponds to a VPN network to which the virtual machine belongs; and a controlling VPN client in one of physical hosts may also establish correspondence between a VPN network and a VNC on each of the physical hosts according to a preconfigured VPN security communication policy, and map a network card in each virtual machine on each of the physical hosts respectively to a VNC on a physical host where the virtual machine is located, where the VNC corresponds to a VPN network to which the virtual machine where the network card is located belongs, and share the established correspondence and a mapping result with controlled VPN clients in other physical hosts.

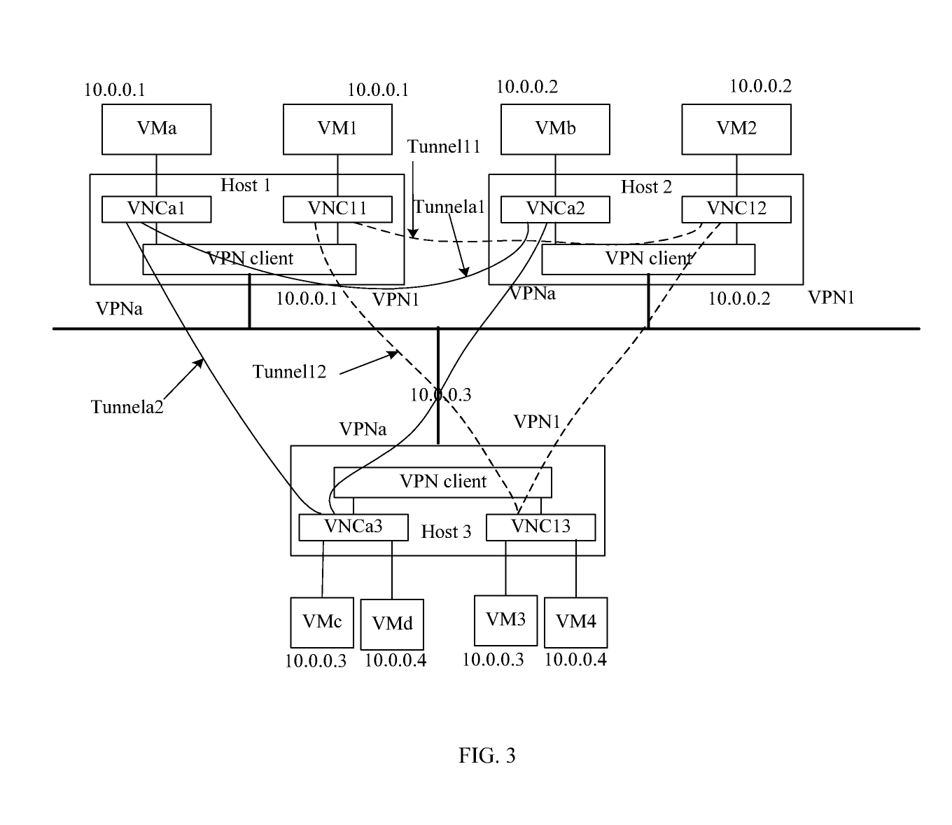

FIG. 3 is a schematic view of communication between virtual machines in Embodiment 2 of the network communication method according to the present invention. As shown in FIG. 3, it is assumed that three physical hosts, which are respectively three host operating systems Host 1, Host 2, and Host 3, are set in a virtual network, virtual machines VMa and VM1 are installed on Host1, virtual machines VMb and VM2 are installed on Host2, and virtual machines VMc, VMd, VM3, and VM4 are installed on Host3. It is preconfigured that the virtual machines VMa, VMb, VMc, and VMd belong to a VPNa network and that the virtual machines VM1, VM2, VM3, and VM4 belong to a VPN1 network. The two VPN networks are isolated from each other. Two virtual network cards VNCa1 and VNC11 are set on Host1, two virtual network cards VNCa2 and VNC12 are set on Host2, and two virtual network cards VNCa3 and VNC13 are set on Host3. VNCa1, VNCa2, and VNCa3 correspond to the VPNa network, and VNC11, VNC12, and VNC13 correspond to the VPN1 network. This step is establishing correspondence between a VPN network and a VNC according to a preconfigured VPN security communication policy, that is, establishing correspondence between the VPNa network and the three network cards of VNCa1, VNCa2, and VNCa3, and establishing correspondence between the VPN1 network and VNC11, VNC12, and VNC13; and mapping, according to the correspondence between the VPN network and the VNC, virtual network cards of virtual machines to VNCs corresponding to VPN networks to which the virtual machines belong, that is, mapping a virtual network card of VMa to VNCa1 corresponding to the VPNa network to which VMa belongs, mapping a virtual network card of VMb to VNCa2 corresponding to the VPNa network to which VMb belongs, mapping virtual network cards of VMc and VMd to VNCa3 corresponding to the VPNa network to which VMc and VMd belong, mapping a virtual network card of VM1 to VNC11 corresponding to the VPN1 network to which VM1 belongs, mapping a virtual network card of VM2 to VNC12 corresponding to the VPN1 network to which VM2 belongs, and mapping virtual network cards of VM3 and VM4 to VNC13 corresponding to the VPN1 network to which VM3 and VM4 belong.

Step 202: The VPN client in the physical host establishes, according to the preconfigured VPN security communication policy, tunnels between the physical host and other physical hosts where virtual machines belonging to the same VPN network are located.

In this embodiment, tunnels are established between the physical hosts, and one tunnel corresponds to two virtual machines in one VPN network that are set on different physical hosts. The process of establishing a tunnel is as follows: After a VPN client in a physical host 1 obtains source and destination addresses of a network communication packet sent by a virtual machine on the physical host and a VPN network to which the network communication packet belongs, the VPN client in the physical host 1 first needs to search in the VPN network for the real IP address (a unique address in the Internet) of a physical host 2 where a virtual machine identified by the destination address is located, and then establishes a tunnel between the physical host 1 and the physical host 2, and meanwhile records correspondence between the tunnel and the source address and the destination address of the network packet, and the VPN network to which the network communication packet belongs. Then, the network communication packet can be encapsulated into a corresponding tunnel according to the source address and the destination address of the network communication packet, and the VPN network to which the network communication packet belongs. Tunneling (Tunneling) is a manner of transferring data between networks by using the infrastructure of the Internet. Data (or load) transferred by using a tunnel may be a data frame or a packet of a different protocol. A data frame or a packet of other protocols is re-encapsulated by a tunneling protocol and then is sent through a tunnel.

Specifically, only one tunnel may be established between two physical hosts where different virtual machines belonging to the same VPN network are located, or multiple tunnels may be established between two physical hosts where different virtual machines belonging to the same VPN network are located. Taking FIG. 3 as an example, for the first tunnel establishment method, because VMb, VMc, and VMd belong to the VPNa network, and VMb is set on Host2, and VMc and VMd are both set on Host3, only one tunnel in the VPNa network needs to be established between Host2 and Host3, and the tunnel is identified by real IP addresses of Host2 and Host3. For the second tunnel establishment method, at least two tunnels in the VPNa network need to be established between Host2 and Host3, which are a tunnel identified by virtual IP addresses of VMb and VMc and a tunnel identified by virtual IP addresses of VMb and VMd.

Step 203: A VPN network card VNC on the physical host receives a network communication packet sent by a first virtual machine of which a host machine is the physical host and which has a mapping relationship with the VNC.

This step is that: a VPN network card VNC on the physical host receives a network communication packet sent by a first virtual machine of which a host machine is the physical host and which has a mapping relationship with the VNC, where a source address carried in the network communication packet is an address of the first virtual machine, and a destination address carried in the network communication packet is an address of a second virtual machine of which a host machine is other physical hosts or address of another physical host. In this embodiment, a network communication packet sent between virtual machines is first captured by a VNC corresponding to the first virtual machine, where a source address and a destination address are carried in the network communication packet. Herein, the source address may be a MAC address or a virtual IP address of the first virtual machine, and the destination address may be a MAC address or a virtual IP address of the second virtual machine, or a MAC address or a virtual IP address of another physical host. For example, it is assumed that VMa communicates with VMb, VMa sends a network communication packet to VMb, and a virtual IP address of VMa and a virtual IP address of VMb are carried in the network communication packet, then before being sent to VMb, the network communication packet is first captured by VNCa1 on Host1 where VMa is located.

Step 204: The VPN client on the physical host selects a VPN network corresponding to the VNC on the physical host according to the preset correspondence between the VPN network and the VNC.

After capturing the network communication packet sent by the first virtual machine, the VPN client on the physical host selects, according to the VNC that receives the network communication packet and according to the preset correspondence between the VPN network and the VNC, a VPN network corresponding to the VNC that receives the network communication packet, that is, obtains a VPN network to which the first virtual machine belongs, so as to learn the VPN network to which the network communication packet belongs. In this embodiment, multiple virtual machines and multiple VNCs are set on the physical host, and each VNC corresponds to one VPN network. Taking FIG. 3 as an example, the VPNa network corresponds to VNCa1, VNCa2, and VNCa3, and the VPN1 network corresponds to VNC11, VNC12, and VNC13. After a VNC on the physical host receives a network communication packet, the VPN client in the physical host may first select, according to the correspondence between the VPN network and the VNC, a VPN network corresponding to the VNC that receives the network communication packet. For example, when VM 1 sends a network communication packet to VM2, and VNC11 receives the network communication packet from VM1, then the physical host may select the VPN1 network that is a VPN network corresponding to VNC11.

Step 205: After encapsulating the network communication packet according to a preset tunneling protocol, the VPN client in the physical host sends the encapsulated network communication packet through a tunnel in the selected VPN network.

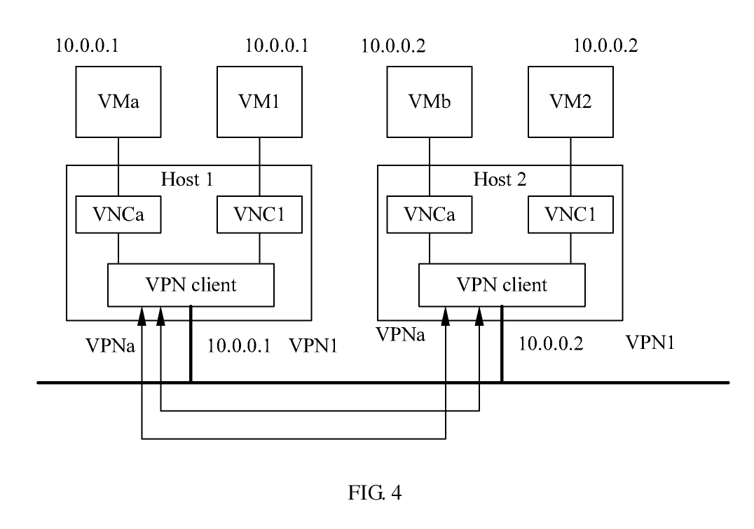

In this embodiment, after the physical host receives the network communication packet, if the first virtual machine and the second virtual machine do not correspond to the same VNC, the physical host first encapsulates the network communication packet according to a preset tunneling protocol and then sends the network communication packet through the tunnel. Specifically, in the selected VPN network, only one default tunnel starting from the physical host may be set, or more than one tunnel starting from the physical host may be set, and for the two different situations, the physical host uses different methods to send the network communication packet. If the selected VPN network has only one default tunnel starting from the physical host, the encapsulated network communication packet is directly sent to the second virtual machine or other physical hosts through the default tunnel, and it is unnecessary to select a tunnel according to a destination address of the network communication packet. If the selected VPN network has more than one tunnel on the physical host, and the tunnels specifically correspond to virtual addresses of virtual machines in the VPN network, the physical host first extracts a destination address carried in the network communication packet from the network communication packet, selects a tunnel corresponding to the extracted destination address according to correspondence between the tunnel and the address, and then sends the encapsulated network communication packet to the second virtual machine or other physical hosts through the selected tunnel. As shown in FIG. 3 and FIG. 4, FIG. 3 specifically corresponds to the situation that multiple tunnels starting from one physical host exist in one VPN network, and FIG. 4 specifically corresponds to the situation that only one default tunnel starting from one physical host exists in one VPN network.

As shown in FIG. 4, when only one default tunnel starting from one physical host exists in a VPN network, if VMa sends a network communication packet to VMb, after receiving the network communication packet, VNCa1 corresponding to VMa selects VPNa that is a VPN network corresponding to VNCa1, and after encapsulating the network communication packet, Host 1 may directly send the encapsulated network communication packet to VMb through a default tunnel starting from Host1 in VPNa, and it is unnecessary to select a tunnel according to a destination address.

In this embodiment, when multiple tunnels starting from one physical host exist in one VPN network, for FIG. 3, a table of correspondence between tunnels established on Host1 and addresses may be shown in Table 1, where the destination address of the network communication packet may be a virtual IP address or a MAC address of the second virtual machine, or a MAC address or a virtual IP address of the physical host in which the second virtual machine located, and a virtual IP address is taken as an example for illustration herein.

TABLE 1
Table of correspondence between tunnels and addresses

| VPN network | Tunnel No. | Virtual IP address |
|---|---|---|
| VPNa network | Tunnela1 | 10.0.0.2 |
| | Tunnela2 | 10.0.0.3 |
| | Tunnela2 | 10.0.0.4 |
| VPN1 network | Tunnel11 | 10.0.0.2 |
| | Tunnel12 | 10.0.0.3 |
| | Tunnel12 | 10.0.0.4 |

As shown in FIG. 3, when VMa sends a network communication packet to VMb, VNCa1 corresponding to VMa receives the network communication packet and selects VPNa that is a VPN network corresponding to VNCa1. Multiple tunnels starting from Host1 exist in VPNa, and Host1 extracts a destination address 10.0.0.2 of the network communication packet from the network communication packet, and obtains a corresponding tunnel Tunnela1 according to the correspondence table of tunnels and addresses, then Host1 encrypts the network communication packet through a predetermined tunneling protocol and sends the encrypted network communication packet through Tunnela1. In this embodiment, because VMa and VMb belong to VPNa, all network communication packets sent by VMa and VMb, that is, all network traffic generated by VMa and VMb, no matter which protocols the network communication packets belong to and how IP addresses of the network communication packets are set, are encapsulated in Tunnela1 in VPNa. Because VM1 and VM2 belong to VPN1, all network communication packets sent by VM1 and VM2, that is, all network traffic generated by VM1 and VM2, no matter which protocols the network communication packets belong to and how IP addresses of the network communication packets are set, are encapsulated in Tunnel11 in VPN1. It can be seen that, in this embodiment, the VPN to which the traffic generated by a virtual machine belongs is not decided by a routing table of the virtual machine.

By using the network communication method provided by this embodiment, a VNC on a physical host receives a network communication packet sent by a first virtual machine of which a host machine is the physical host and which has a mapping relationship with the VNC, a VPN network corresponding to the VNC is selected according to preset correspondence between the VPN network and the VNC, and the network communication packet is sent through the VPN network. In this embodiment, an IP address of a virtual machine is allowed to be the same as an IP address of a physical host, and the same IP address is allowed to be set for different virtual machines that are installed on the same virtual machine management system and belong to different VPN networks, so as to lift the restriction on setting an IP address of a virtual machine in a VPN. Each service system can set by itself an IP address of a virtual machine in the system, and it is unnecessary to consider the problem of an address conflict with a host or virtual machines in other service systems.

In this embodiment, it is unnecessary to install a VPN software client on a Guest operating system (OS), and a user on the Guest OS does not sense the existence of a VPN, so that different clients do not need to be developed according to different Guest OSs, and while the deployment is simplified, it can also be guaranteed that a user on a virtual machine cannot perform any operation on a VPN client, so that a VPN security policy cannot be intervened in. In this embodiment, network traffic of all virtual machines is controlled by a VNC, and the VNC corresponds to a specific VPN network; therefore, network traffic between virtual machines is only transmitted in a VPN network and can be received and processed by only other nodes in the VPN network, and traffic of virtual machines that belong to different VPN networks is isolated by a VPN tunnel. In this embodiment, taking FIG. 3 as an example, if IP addresses of virtual machines are set to: VMa:10.0.0.1, VM1:10.0.0.1, VMb:10.0.0.2, and VM2:10.0.0.2, and when VMa communicates with VMb, a network communication packet is processed by VNCa1 on Host 1 and is sent to VNCa2 on Host2 and then is forwarded by VNCa2 on Host 2 to VMb. In the process, because of the isolation function of a VNC, the network communication packet is not received by VM2 having the same IP address as VMb. In addition, because of the isolation function of a VPN tunnel corresponding to the VNC, VMa and VMb, and VM1 and VM2 do not have an address conflict though they are installed on the same host, and VMa and VMb cannot communicate with VM1 and VM2, and vice versa, even though IP addresses of the same network segment are set, so as to eliminate the possibility that virtual machines communicate with each other in a host system by circumventing a VPN client.

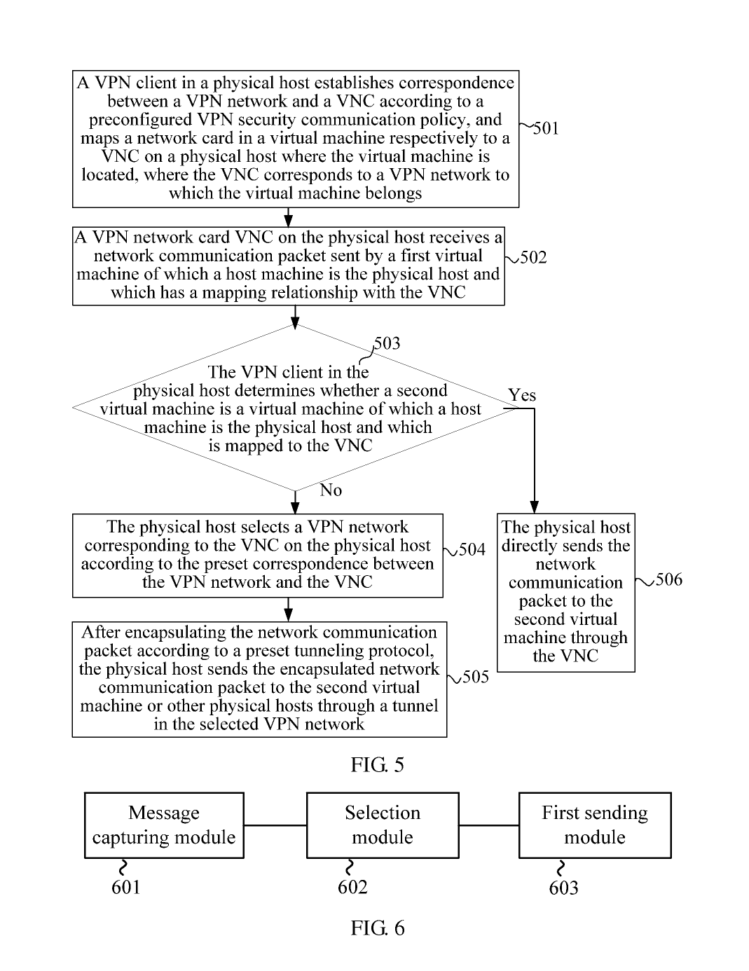

FIG. 5 is a flow chart of Embodiment 3 of the network communication method according to the present invention. As shown in FIG. 5, this embodiment provides a network communication method, which may specifically include the following steps:

Step 501: A VPN client in a physical host establishes correspondence between the VPN network and the VNC according to a preconfigured VPN security communication policy, and maps a network card in a virtual machine to a VNC on a physical host where the virtual machine is located, where the VNC corresponds to a VPN network to which the virtual machine where the network card located belongs. This step may be similar to step 201, which is not described herein again.

Step 502: A VPN network card VNC on the physical host receives a network communication packet sent by a first virtual machine of which a host machine is the physical host and which has a mapping relationship with the VNC.

A source address carried in the network communication packet is an address of the first virtual machine, and a destination address carried in the network communication packet is an address of a second virtual machine or an address of another physical host.

Step 503: The VPN client in the physical host determines whether the second virtual machine is a virtual machine of which a host machine is the physical host and which is mapped to the VNC, and if yes, step 506 is performed; otherwise, step 504 is performed.

The VPN client in the physical host determines whether the second virtual machine is a virtual machine of which a host machine is the physical host and which is mapped to the VNC, and if the second virtual machine is not the virtual machine of which the host machine is the physical host and which is mapped to the VNC (that is, the second virtual machine and the first virtual machine do not correspond to the same VNC on the same physical host), step 504 to step 505 are performed; if the second virtual machine is the virtual machine of which the host machine is the physical host and which is mapped to the VNC (that is, the second virtual machine and the first virtual machine correspond to the same VNC), step 506 is performed.

In this embodiment, the destination address carried in the network communication packet is an address of the second virtual machine of which the host machine is the physical host and which corresponds to the same VNC. That is, in this embodiment, a network communication packet is sent between two virtual machines corresponding to the same VNC on the same physical host, and in this embodiment, a network communication packet sent between virtual machines is first captured by a VNC corresponding to the first virtual machine. Herein, the source address may be a MAC address or a virtual IP address of the first virtual machine, and the destination address may be a MAC address or a virtual IP address of the second virtual machine. For example, taking FIG. 3 as an example, it is assumed that VMc communicates with VMd, VMc sends a network communication packet to VMd, and a virtual IP address of VMc and a virtual IP address of VMd are carried in the network communication packet, then before being sent to VMd, the network communication packet is captured by VNCa3 on Host3 where VMc is located.

A VPN client on Host3 may determine, according to a mapping relationship between addresses of virtual machines and VNCs, which is stored when “mapping network cards in virtual machines respectively to VNCs corresponding to VPN networks to which the virtual machines belong” in step 501, whether a destination of the network communication packet is another virtual machine that is mapped to the same VNC as the first virtual machine.

Step 504: The physical host selects a VPN network corresponding to the VNC on the physical host according to the preset correspondence between the VPN network and the VNC. This step may be similar to step 204, which is not described herein again.

Step 505: After encapsulating the network communication packet according to a preset tunneling protocol, the physical host sends the encapsulated network communication packet to the second virtual machine or other physical hosts through a tunnel in the selected VPN network. This step may be similar to step 205, which is not described herein again.

Step 506: The physical host directly sends the network communication packet to the second virtual machine through the VNC.

Because in this embodiment, specifically, two virtual machines that are mapped to the same VNC communicate with each other, the network communication packet does not need to be sent through a tunnel in the VPN network. After selecting the VPN network corresponding to the VNC on the physical host, the physical host may directly send the network communication packet to the second virtual machine on the physical host through the VNC. Still taking FIG. 3 as an example, it is assumed that VMc sends a network communication packet to VMd, and VMc and VMd are both mapped to VNCa3 on Host3, then Host3 may directly forward the network communication packet to VMd through VNCa3.

It should be noted that, the network communication method shown in FIG. 5 is just one improved solution for the situation that at least two virtual machines are mapped to one VNC, and if only one virtual machine is mapped to one VNC, step 503 and step 506 do not need to be performed. In addition, even though at least two virtual machines are mapped to one VNC, other solutions may be provided. For example, if the procedure shown in FIG. 2 is adopted for processing, after the VPN network is selected in step 204, in step 205, the network communication packet is sent through any tunnel in the selected VPN network, and is forwarded many times by other VNCs, corresponding to the selected VPN network, on other physical hosts, and in the end the network communication packet still can reach the second virtual machine mapped to the same VNC as the first virtual machine that sends the network communication packet.

By using the network communication method provided by this embodiment, a VNC on a physical host receives a network communication packet sent by a first virtual machine of which a host machine is the physical host and which has a mapping relationship with the VNC, and if a destination end of the network communication packet is a second virtual machine mapped to the same VNC as the first virtual machine, the network communication packet is directly sent through the VNC. In this embodiment, an IP address of a virtual machine is allowed to be the same as an IP address of a physical host, and the same IP address is allowed to be set for different virtual machines that are installed on the same virtual machine management system and belong to different VPN networks, so as to lift the restriction on setting an IP address of a virtual machine in a VPN. Each service system can set by itself an IP address of a virtual machine in the system without considering the problem of an address conflict with a host or virtual machines in other service systems.

It can be understood by persons of ordinary skill in the art that, all or a part of the steps that implement the foregoing method embodiments may be implemented by a program instructing relevant hardware. The foregoing program may be stored in a computer readable storage medium. When the program is run, the steps in the foregoing method embodiments are performed, and the storage medium includes all kinds of media that can store a program code, such as a ROM, a RAM, a magnetic disk, or an optical disk.

FIG. 6 is a structural diagram of Embodiment 1 of a network communication device according to the present invention. As shown in FIG. 6, this embodiment provides a network communication device, which may specifically perform the steps in Embodiment 1 of the method, which is not described herein again. The network communication device provided by this embodiment may specifically include a packet capturing module 601, a selection module 602, and a first sending module 603. The packet capturing module 601 is configured to receive a network communication packet sent by a first virtual machine of which a host machine is the physical host and which has a mapping relationship with the VNC, where a source address carried in the network communication packet is an address of the first virtual machine, and a destination address carried in the network communication packet is an address of a second virtual machine or address of another physical host. The selection module 602 is configured to select a VPN network corresponding to the VNC on the physical host according to preset correspondence between the VPN network and the VNC. The first sending module 603 is configured to send the network communication packet through the selected VPN network.

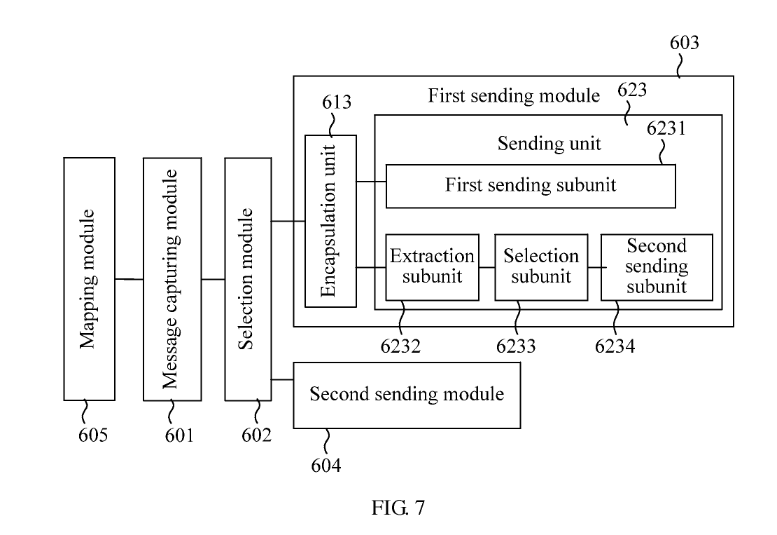

FIG. 7 is a structural diagram of Embodiment 2 of the network communication device according to the present invention. As shown in FIG. 7, this embodiment provides a network communication device, which may specifically perform the steps in Embodiment 2 or Embodiment 3 of the method, which is not described herein again. In the network communication device provided by this embodiment, based on FIG. 6, the first sending module 603 may specifically include an encapsulation unit 613 and a sending unit 623. The encapsulation unit 613 is configured to encapsulate the network communication packet according to a preset tunneling protocol. The sending unit 623 is configured to send the encapsulated network communication packet through a tunnel in the selected VPN network, where the second virtual machine is a virtual machine of which a host machine is another physical host.

Specifically, in this embodiment, the sending unit 623 may specifically include a first sending subunit 6231. The first sending subunit 6231 is configured to send the encapsulated network communication packet through the default tunnel if only one default tunnel starting from the physical host exists in the selected VPN network.

Furthermore, in this embodiment, the sending unit 623 may further include an extraction subunit 6232, a selection subunit 6233, and a second sending subunit 6234. The extraction subunit 6232 is configured to extract the destination address from the network communication packet if at least two tunnels exist in the selected VPN network. The selection subunit 6233 is configured to select a tunnel corresponding to the extracted destination address according to correspondence between the tunnel and the destination address. The second sending subunit 6234 is configured to send the encapsulated network communication packet through the selected tunnel.

Specifically, in this embodiment, the selection module 602 may be specifically configured to select a VPN network corresponding to the VNC on the physical host according to the preset correspondence between the VPN network and the VNC when determining that the second virtual machine is not a virtual machine of which a host machine is the physical host and which has a mapping relationship with the VNC.

Furthermore, the network communication device provided by this embodiment may further include a second sending module 604. The second sending module 604 is configured to directly send the network communication packet to the second virtual machine through the VNC when determining that the second virtual machine is a virtual machine of which a host machine is the physical host and which has a mapping relationship with the VNC.

Furthermore, the virtual network communication device provided by this embodiment may further include a mapping module 605. The mapping module 605 is configured to: before the VPN network card VNC on the physical host receives the network communication packet sent by the first virtual machine of which the host machine is the physical host and which has the mapping relationship with the VNC, establish the correspondence between the VPN network and the VNC according to a preconfigured VPN security communication policy, and map a network card in a virtual machine respectively to a VNC on the host machine, wherein the VNC corresponds to a VPN network to which the virtual machine where the network card is located belongs.

Furthermore, in this embodiment, the address includes a MAC address and a virtual IP address in a VPN network.

Through the network communication device provided by this embodiment, a VNC on a physical host receives a network communication packet sent by a first virtual machine of which a host machine is the physical host and which has a mapping relationship with the VNC, a VPN network corresponding to the VPN network card is selected according to preset correspondence between the VPN network and the VNC, and the network communication packet is sent through the selected VPN network. Through this solution, it is unnecessary to install VPN software on each virtual machine, which simplifies the setting procedure, an IP address of a virtual machine is allowed to be the same as an IP address of a physical computer, and the same IP address is allowed to be set for different virtual machines that are installed on the same virtual machine management system and belong to different VPN networks, so as to lower the restriction on setting an IP address of a virtual machine in a VPN.

Finally, it should be noted that the foregoing embodiments are merely intended for describing the technical solutions of the present invention, other than limiting the present invention. Although the present invention is described in detail with reference to the foregoing embodiments, persons of ordinary skill in the art should understand that they may still make modifications to the technical solutions described in the foregoing embodiments, or make equivalent substitutions to some or all the technical features thereof, without departing from the spirit and scope of the technical solutions of the embodiments of the present invention.

1. A network communication method, comprising:
receiving, by a Virtual Private Network (VPN) network card (VNC) on a physical host, a network communication packet sent by a first virtual machine of which a host machine is the physical host and which has a mapping relationship with the VNC, wherein a source address carried in the network communication packet is an address of the first virtual machine, and wherein a destination address carried in the network communication packet is an address of a second virtual machine or an address of another physical host;
selecting, by the physical host, a VPN network corresponding to the VNC on the physical host according to preset correspondence between the VPN network and the VNC; and
sending, by the physical host, the network communication packet through the selected VPN network.

2. The method according to claim 1, wherein sending, by the physical host, the network communication packet through the selected VPN network comprises sending, by the physical host, an encapsulated network communication packet through a tunnel in the selected VPN network after encapsulating the network communication packet according to a preset tunneling protocol, and wherein the second virtual machine is a virtual machine of which a host machine is another physical host.

3. The method according to claim 2, wherein sending the encapsulated network communication packet through the tunnel in the selected VPN network comprises, sending the encapsulated network communication packet through a default tunnel when only one default tunnel starting from the physical host exists in the selected VPN network.

4. The method according to claim 2, wherein sending the encapsulated network communication packet through the tunnel in the selected VPN network comprises:
extracting the destination address from the network communication packet when at least two tunnels starting from the physical host exist in the selected VPN network;
selecting a tunnel corresponding to the extracted destination address according to correspondence between the tunnel and the destination address; and
sending the encapsulated network communication packet through the selected tunnel.

5. The method according to claim 1, wherein before selecting, by the physical host, the VPN network corresponding to the VNC on the physical host according to preset correspondence between the VPN network and the VNC, the method further comprises determining, by the physical host, that the second virtual machine is not a virtual machine of which a host machine is the physical host and which has a mapping relationship with the VNC.

6. The method according to claim 5, wherein after determining, by the physical host, that the second virtual machine is a virtual machine of which a host machine is the physical host and which has a mapping relationship with the VNC, the method further comprises directly sending the network communication packet to the second virtual machine through the VNC.

7. The method according to claim 1, wherein before receiving, by the VPN network card VNC on the physical host, the network communication packet sent by the first virtual machine of which the host machine is the physical host and which has the mapping relationship with the VNC, the method further comprises:
establishing, by the physical host, the correspondence between the VPN network and the VNC according to a preconfigured VPN security communication policy; and
mapping a network card in a virtual machine to a VNC on the host machine, wherein the VNC corresponds to a VPN network to which the virtual machine where the network card located belongs.

8. The method according to claim 1, wherein the address comprises a media access control (MAC) address and a virtual Internet Protocol (IP) address in a VPN network.

9. A network communication device, comprising:
a packet capturing module configured to receive, through a VNC on a physical host where the network communication device is located, a network communication packet sent by a first virtual machine of which a host machine is the physical host and which has a mapping relationship with the VNC, wherein a source address carried in the network communication packet is an address of the first virtual machine, and wherein a destination address carried in the network communication packet is an address of a second virtual machine or an address of another physical host;
a selection module configured to select a VPN network corresponding to the VNC on the physical host according to preset correspondence between the VPN network and the VNC; and
a first sending module configured to send the network communication packet through the selected VPN network.

10. The device according to claim 9, wherein the first sending module comprises:
an encapsulation unit configured to encapsulate the network communication packet according to a preset tunneling protocol; and
a sending unit configured to send the encapsulated network communication packet through a tunnel in the selected VPN network, wherein the second virtual machine is a virtual machine of which a host machine is another physical host.

11. The device according to claim 10, wherein the sending unit comprises a first sending subunit configured to send the encapsulated network communication packet through the default tunnel if only one default tunnel starting from the physical host exists in the selected VPN network.

12. The device according to claim 10, wherein the sending unit comprises:
an extraction subunit configured to extract the destination address from the network communication packet when at least two tunnels starting from the physical host exist in the selected VPN network;
a selection subunit configured to select a tunnel corresponding to the extracted destination address according to correspondence between the tunnel and the destination address; and
a second sending subunit configured to send the encapsulated network communication packet through the selected tunnel.

13. The device according to claim 9, wherein the selection module is specifically configured to select a VPN network corresponding to the VNC on the physical host according to the preset correspondence between the VPN network and the VNC when determining that the second virtual machine is not a virtual machine of which a host machine is the physical host and which has a mapping relationship with the VNC.

14. The device according to claim 13, further comprising a second sending module, configured to directly send the network communication packet to the second virtual machine through the VNC when determining that the second virtual machine is a virtual machine of which a host machine is the physical host and which has a mapping relationship with the VNC.

15. The device according to claim 9, further comprising a mapping module configured to:
establish the correspondence between the VPN network and the VNC according to a preconfigured VPN security communication policy before the VPN network card VNC on the physical host receives the network communication packet sent by the first virtual machine of which the host machine is the physical host and which has the mapping relationship with the VNC; and
map a network card in a virtual machine to a VNC on the host machine, wherein the VNC corresponds to a VPN network to which the virtual machine where the network card is located belongs before the VPN network card VNC on the physical host receives the network communication packet sent by the first virtual machine of which the host machine is the physical host and which has the mapping relationship with the VNC.

16. The method according to claim 2, wherein the address comprises a MAC address and a IP address in a VPN network.

17. The method according to claim 3, wherein the address comprises a MAC address and a IP address in a VPN network.

18. The method according to claim 4, wherein the address comprises a MAC address and a IP address in a VPN network.

19. The method according to claim 5, wherein the address comprises a MAC address and a IP address in a VPN network.

20. The method according to claim 6, wherein the address comprises a MAC address and a IP address in a VPN network.

21. The method according to claim 7, wherein the address comprises a MAC address and a IP address in a VPN network.
